(19) United States
(12) Patent Application Publication
(10) Pub. No.: US 2004/0163937 A1
(43) Pub. Date: Aug. 26, 2004

(54) Keyboard switch mechanism

(75) Inventor: Hideki Ito, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/780,997

(22) Filed: Feb. 18, 2004

(30) Foreign Application Priority Data
Feb. 24, 2003 (JP) 2003-046462

(51) Int. Cl. H01H 13/70

(52) U.S. Cl. 200/5 A

(57) ABSTRACT

The present invention provides a keyboard switch which can reduce the number of assembly processes by decreasing the number of components and which can be easily assembled. First to third link members 5, 6 and 7 of a keyboard switch of the present invention include one end portions 5a, 6a and 7a and the other end portions 5g, 6g and 7g, which face each other. The first to third link members 5, 6 and 7 are installed so as not to cross each other, and have their one end portions 5a, 6a and 7a slidably supported by first to third slide supporting portions 3a, 3b and 4a formed on a key top, and their other end portions 5g, 6g and 7g rotatably supported by first to third rotating supporting portions 10a, 10b and 10c formed on a base plate 10.

### BACKGROUND OF THE INVENTION

1. Field of the Invention

The present invention relates to a keyboard switch, and more particularly to a keyboard switch for supporting a key top with a plurality of link members.

2. Description of the Related Art

A conventional keyboard switch will now be explained with reference to FIG. 15. The conventional keyboard switch 21 includes a base frame 22 on the lower side, and a key top 23 on the upper side facing the base frame 22.

A membrane switch 24 formed by stacking three layers of film sheets is installed on the lower side of the base frame 22 and is inserted between a metal panel 25 and the base frame 22.

In addition, a circular hole 26 is formed on the base frame 22, slide guides 27 and 28 lifted from the base frame 22 and extended to the outside in parallel to the base frame 22 are formed around the circular hole 26, and lower rotating shafts 33b, 33b of a pair of link members 33, 33 are slidably supported by the slide guides 27 and 28.

In addition, split type bearings 30 and 31 for rotatably supporting upper rotating shafts 33a, 33a of the link members 33, 33 are formed on the back surface of the key top 23.

Pedestals 35 and 36 protrude from the base frame 22 outside the slide guides 27 and 28, respectively.

Before assembling the key top 23, when the lower rotating shafts 33b, 33b of the link members 33, 33 are inserted into the slide guides 27 and 28 in the level state, the upper rotating shafts 33a thereof are position-determined on the pedestals 35 and 36, respectively.

In addition, an elastic member 39 having a dome-shaped inside is mounted on the circular hole 26 of the base frame 22, and an upper end portion 39a of the elastic member 39 is position-determined on a position determining portion 23a of the key top 23.

In the assembly process of the conventional keyboard switch 21 as described above, the membrane switch 24 is inserted between the base frame 22 and the metal panel 25, and then the elastic member 39 is adhered to the circular hole 26 of the base frame 22 using an adhesive.

Then, the lower rotating shafts 33b, 33b of the link members 33, 33 are inserted into the slide guides 27 and 28 of the base frame 22, and the upper rotating shafts 33a, 33a thereof are positioned on the pedestals 35 and 36, so that the link members 33, 33 can be position-determined in parallel to the base frame 22.

When the upper rotating shafts 33a, 33a of the link members 33, 33 are position-determined on the pedestals 35 and 36 formed on the base frame 22, the position determining portion 23a of the key top 23 is positioned on the position determining portion 39a of the elastic member 39 in the upper portions of the link members 33, 33, and the key top 23 is pressed downward. Therefore, the upper rotating shafts 33a of the link members 33 position-determined on the pedestals 35 and 36 are inserted into the split type bearings 30 and 31.

And then, when pressure applied to the key top 23 is removed, the key top 23 is lifted to a predetermined position by an elastic force of the elastic member 39, and the lower rotating shafts 33b, 33b of the link members 33, 33 slide into the slide guides 27 and 28 to lift the upper rotating shafts 33a, 33a.

[Patent Document 1]

Japanese Unexamined Patent Application Publication No. 11-16440

However, the conventional keyboard switch 21 requires the pedestals 35 and 36 that are members for determining the positions of the link members 33, 33 and thus uses the base frame 22, thereby increasing the number of components.

In addition, in an assembly process, the upper rotating shafts 33a, 33a of the link members 33, 33 must be position-determined on the pedestals 35 and 36 formed on the base frame 22, thereby increasing the number of assembly processes.

### SUMMARY OF THE INVENTION

The present invention is contrived to solve the above problems. An object of the present invention is to provide a keyboard switch which can reduce the number of components by removing a base frame and which can be easily assembled by decreasing the number of assembly processes.

As a first means for solving the problems, a keyboard switch according to the present invention includes a key top, a base plate installed on the side facing the key top, an insulation film sheet mounted thereon, an elastic member for applying elasticity to the key top at a predetermined height from the base plate, a plurality of link members for supporting the key top to be freely lifted to or lowered from the base plate, and a contact point portion opened or closed by the lifting or lowering operation of the key top,

wherein each of the plurality of link members has one end portion and the other end portion facing each other, the plurality of link members being installed so as not to cross each other with their one end portions slidably supported by slide supporting portions formed on the key top and their other end portions rotatably supported by rotating supporting portions formed on the base plate.

As a second means for solving the problems, each of the plurality of link members has one side portion and the other side portion in orthogonal direction to the one end portion and the other end portion so that the one side portion and the other side portion face each other, first shaft portions protrude to the outside from the one side portion and the other side portion of the one end portion, second shaft portions protrude in the same directions as the first shaft portions from the one side portion and the other side portion of the other end portion, the first shaft portions are slidably supported by the slide supporting portions of the key top, and the second shaft portions are rotatably supported by the rotating supporting portions of the base plate.

As a third means for solving the problems, the plurality of link members includes first, second and third link members, the first and second link members are installed to face each other with the elastic member between them, and the third link member is positioned outside the first and second shaft portions with the first and second shaft portions installed in orthogonal direction to the protrusion directions of the first and second shaft portions of the first and second link members.

As a fourth means for solving the problems, the elastic member applies elasticity to the center portion of the key top, and the first shaft portions of the link members supported by the slide supporting portions of the key top are aligned more closely to the elastic member than the second shaft portions thereof.

As a fifth means for solving the problems, three sets of slide supporting portions are formed to face each other, the first and second slide supporting portions for supporting the first shaft portions of the first and second link members are adjacent to the first supporting walls formed on the key top, and when the key top reaches a predetermined lifting position, the movement of the first shaft portions of the first and second link members is restricted in the first and second slide supporting portions to prevent the key top from being lifted over the predetermined lifting position.

As a sixth means for solving the problems, the third slide supporting portions for supporting the first shaft portions of the third link member are installed on the second supporting walls formed on the key top. The third link member has its other end portions protrude more to the outside than the second shaft portions, and, when the key top reaches the lifting position, the other end portion contacts the base plate, on which the film sheet is mounted, to prevent the key top from being lifted over the lifting position.

As a seventh means for solving the problems, front end portions of each of the first shaft portions of the link members are tapered.

### BRIEF DESCRIPTION OF THE DRAWINGS

FIG. 1 is a plan view illustrating a keyboard switch according to the present invention;

FIG. 2 is a front view illustrating the keyboard switch according to the present invention;

FIG. 3 is a right side view illustrating the keyboard switch according to the present invention;

FIG. 4 is a perspective view illustrating the keyboard switch according to the present invention;

FIG. 5 is a top view illustrating a key top according to the present invention;

FIG. 6 is a cross-sectional view illustrating major portions of the key top according to the present invention;

FIG. 7 is a bottom view illustrating the key top according to the present invention;

FIG. 8 is a plan view illustrating a first link member according to the present invention;

FIG. 9 is a side view illustrating the first link member according to the present invention;

FIG. 10 is a plan view illustrating a second link member according to the present invention;

FIG. 11 is a side view illustrating the second link member according to the present invention;

FIG. 12 is a plan view illustrating a third link member according to the present invention;

FIG. 13 is a side view illustrating the third link member according to the present invention;

FIG. 14 is a view illustrating position relations of the link members according to the present invention; and

FIG. 15 is a cross-sectional view illustrating major parts of a conventional keyboard switch.

### DESCRIPTION OF THE PREFERRED EMBODIMENTS

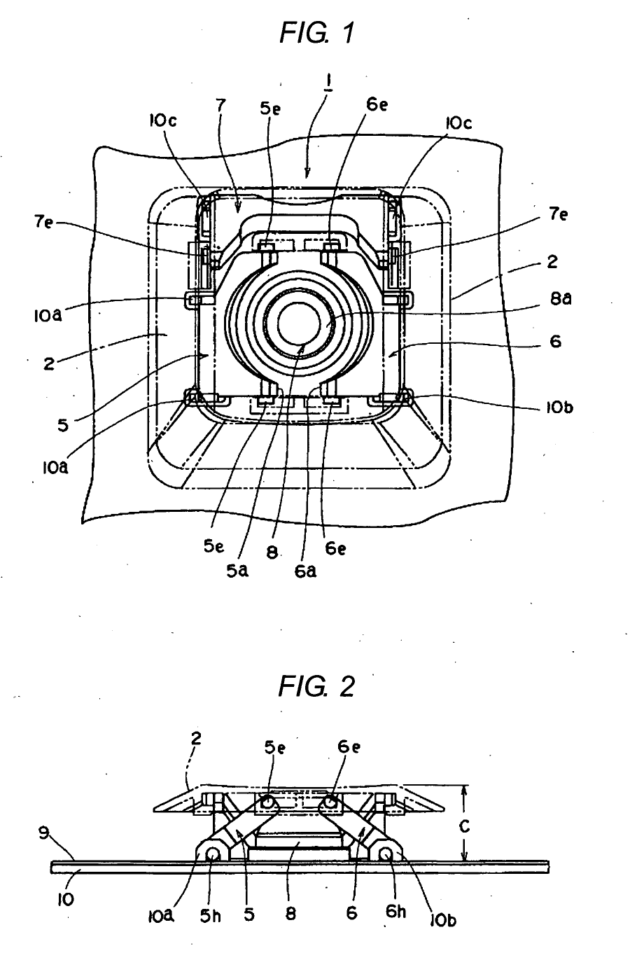

The present invention relates to a keyboard apparatus used for an I/O mechanism such as a personal computer or a keyboard switch suitable for an input switch apparatus. The keyboard apparatus according to the present invention will now be described with reference to FIGS. 1 to 14.

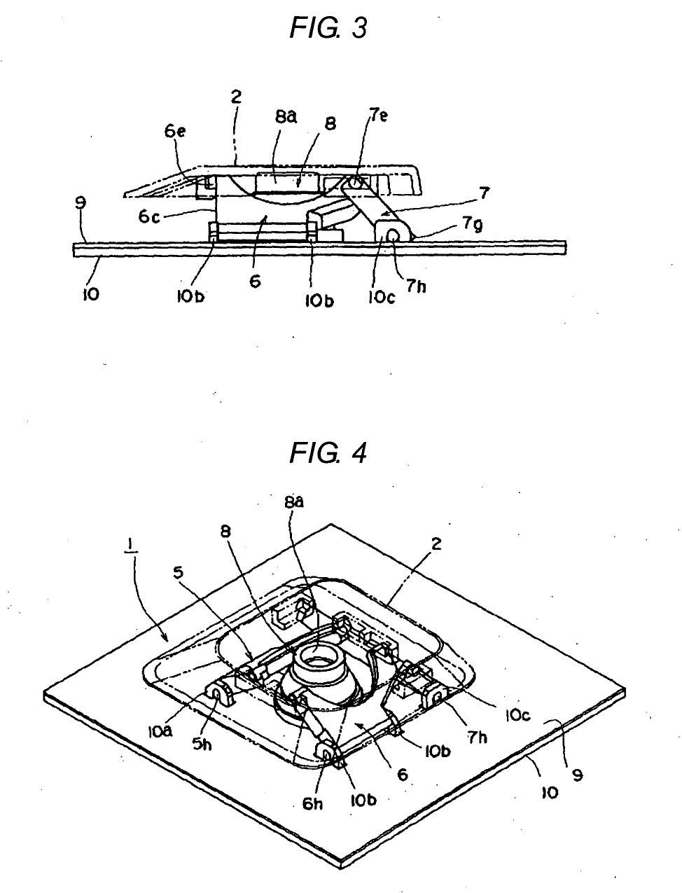

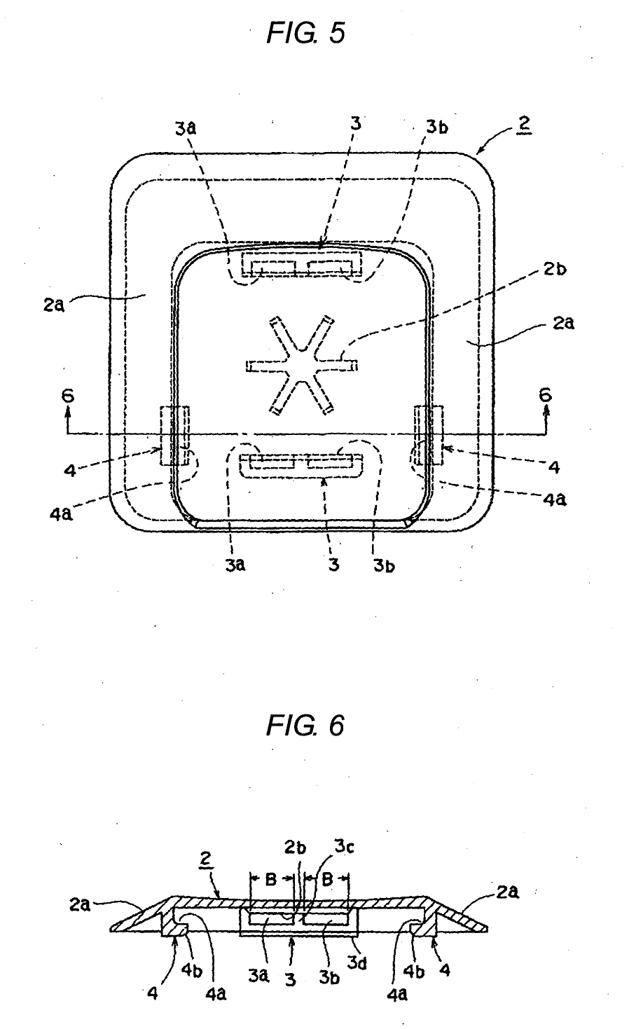

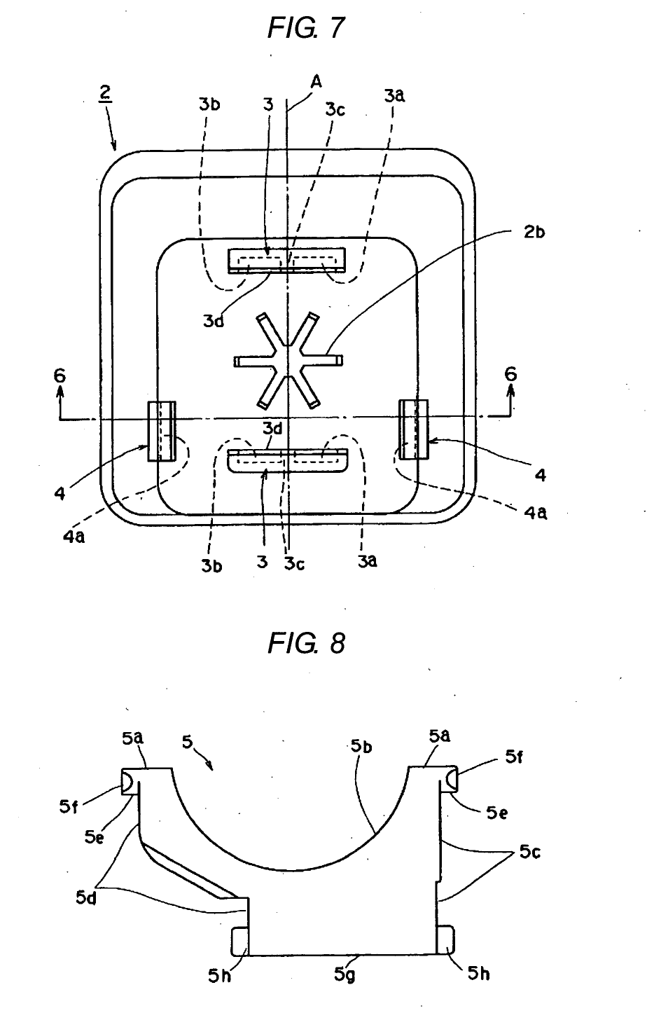

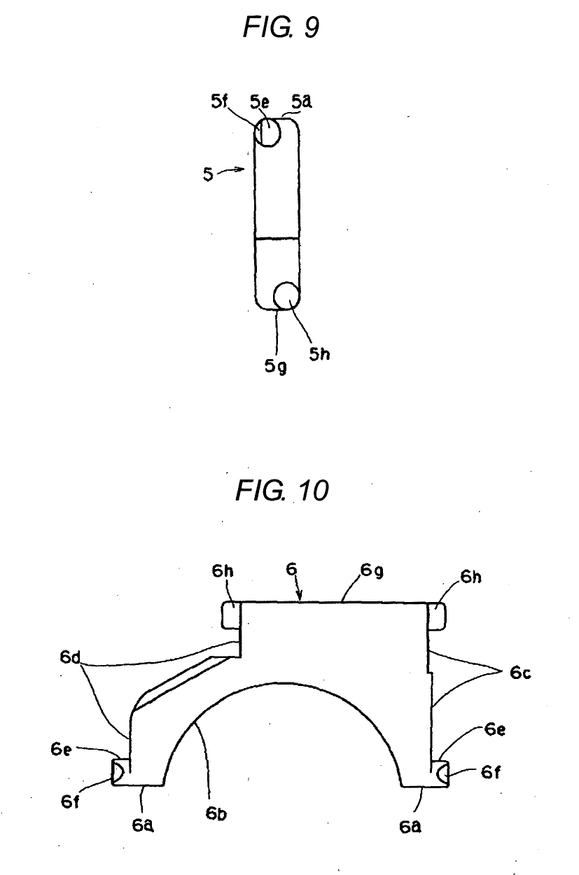

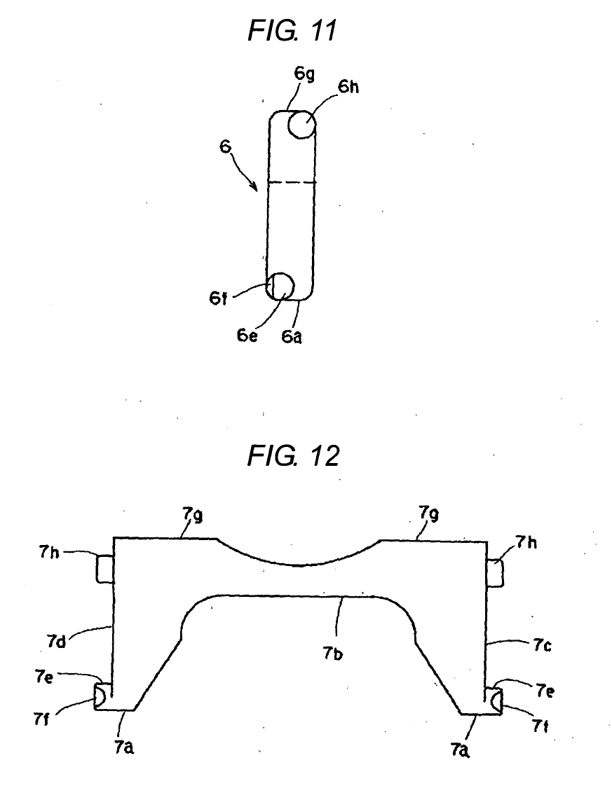

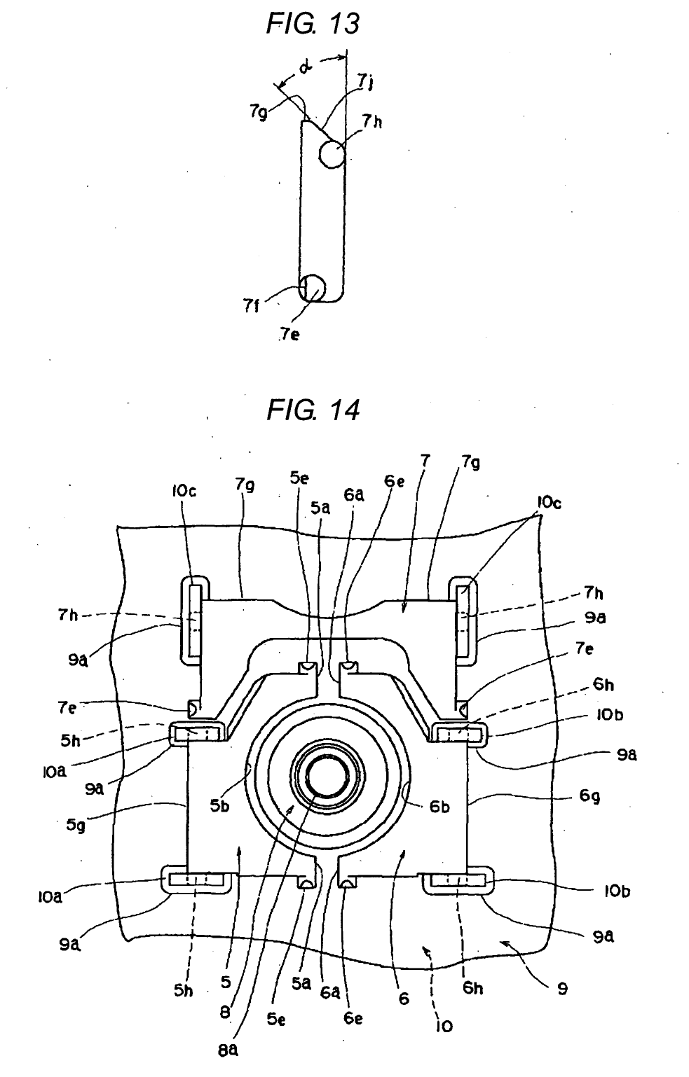

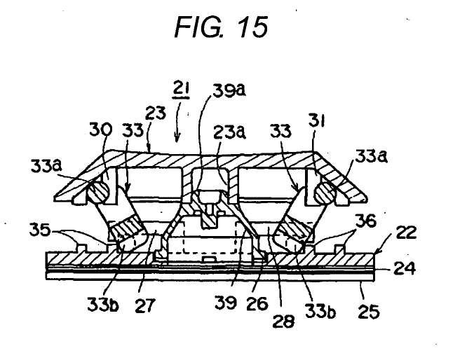

FIG. 1 is a plan view illustrating a keyboard switch according to the present invention. FIG. 2 is a front view illustrating the keyboard switch according to the present invention. FIG. 3 is a right side view illustrating the keyboard switch according to the present invention. FIG. 4 is a perspective view illustrating the keyboard switch according to the present invention. FIG. 5 is a top view illustrating a key top according to the present invention. FIG. 6 is a cross-sectional view illustrating major portions of the key top according to the present invention. FIG. 7 is a bottom view illustrating the key top according to the present invention. FIG. 8 is a plan view illustrating a first link member according to the present invention. FIG. 9 is a side view illustrating the first link member according to the present invention. FIG. 10 is a plan view illustrating a second link member according to the present invention. FIG. 11 is a side view illustrating the second link member according to the present invention. FIG. 12 is a plan view illustrating a third link member according to the present invention. FIG. 13 is a side view illustrating the third link member according to the present invention. FIG. 14 is a view illustrating position relations of the link members according to the present invention.

As illustrated in FIGS. 1 to 4, a key top 2 is installed in the uppermost portion of the keyboard switch 1 according to the present invention. The key top 2 is made of resin. As shown in FIGS. 5 to 7, the outer appearance of the key top 2 is rectangular, and as shown in FIG. 6, the outer circumferential portion of the key top 2 is surrounded by a smooth taper shaped circumference wall 2a, so that the back side of the key top 2 can be concaved.

In addition, a position determining portion 2b extended radially in six directions by a predetermined length protrudes downward from the center portion of the concaved back surface of the key top 2. A position determining portion 8 of an elastic member 8, which will be discussed later, is positioned on the position determining portion 2b to determine the position of the key top 2.

As shown in FIG. 7, a pair of first supporting walls 3, 3 protrude by a predetermined height and face each other in the upper and lower portions of a central line A to cross the position determining portion 2b on the concaved back surface of the key top 2. As illustrated in FIG. 6, angular groove shaped first and second slide supporting portions 3a and 3b are formed in a predetermined width B adjacent to each other with a partition wall 3c between them on the pair of first supporting walls 3, 3.

First shaft portions 5e of a first link member 5, which will be discussed later, are slidably supported by the first slide supporting portions 3a. In addition, first shaft portions 6e of a second link member 6, which will be discussed later, are slidably supported by the second slide supporting portions 3b.

In addition, chamfering portions 3d are formed in predetermined sizes in the facing corner portions of the pair of first supporting walls 3, 3.

Still referring to FIG. 6, a pair of second supporting walls 4, 4 protrudes in a substantially L shape by a predetermined height in order to face each other on the right and left sides of the central line A on the back surface of the key top 2. As shown in FIG. 6, third slide supporting portions 4a having a substantially L-shape are formed on the pair of second supporting walls 4, 4 and first shaft portions 7e of a third link member 7, which will be discussed later, are slidably supported by the third slide supporting portions 4a.

In addition, chamfering portions 4b are formed in predetermined sizes in the facing corner portions of the pair of first supporting walls 4, 4.

As shown in FIG. 8, the first link member 5, slidably supported by the first slide supporting portions 3a, 3a which face each other, has a substantially semicircular notch portion 5b in one end portion 5a of the upper side, and it also has one side portion 5c and the other side portion 5d which face each other in orthogonal direction to the right and left one end portions 5a, 5a with the notch portion 5b between them.

In addition, the first shaft portions 5e, 5e protrude to the outside from the one side portion 5c and the other side portion 5d of the one end portion 5a. As illustrated in FIG. 9, the thickness of the first link member 5 is greater than the diameter of the first shaft portions 5e, chamfering portions 5f are formed at the front ends of the first shaft portions 5e in predetermined sizes, and the front ends of the first shaft portions 5e are tapered.

Furthermore, the first link member 5 includes second shaft portions 5h protruding in the same directions as the first shaft portions 5e in the one side portion 5c and the other side portion 5d of the other end portion 5g on the lower side facing the one end portion 5a.

Furthermore, the second link member 6, slidably supported by the second slide supporting portions 3b, 3b, is installed on the side facing the first link member 5 with the elastic member 8, which will be discussed later, between them. As shown in FIGS. 10 and 11, the second link member 6 is symmetrical to the first link member 5 on the right and left side.

As shown in FIG. 10, the second link member 6 has a substantially semicircular notch portion 6b in one end portion 6a of the lower side, and it also has one side portion 6c and the other side portion 6d which face each other in orthogonal direction to the right and left one end portions 6a, 6a with the notch portion 6b between them.

The first shaft portions 6e, 6e protrude to the outside from the one side portion 6c and the other side portion 6d of the one end portion 6a. As illustrated in FIG. 11, the thickness of the second link member 6 is greater than the diameter of the first shaft portions 6e, chamfering portions 6f are formed at the front ends of the first shaft portions 6e in predetermined sizes, and the front ends of the first shaft portions 6e are tapered.

Furthermore, the second link member 6 includes second shaft portions 6h protruding in the same directions as the first shaft portions 6e in the one side portion 6c and the other side portion 6d of the other end portion 6g on the upper side facing the one end portion 6a.

As described above, as shown in FIG. 14, the elastic member 8, which will be discussed later, is installed on the side facing the semicircular notch portions 5b and 6b of the first and second link members 5 and 6. The first and second link members 5 and 6 are installed on the right and left sides which face each other with the elastic member 8 between them.

Furthermore, a third link member 7, slidably supported by the third slide supporting portions 4a, 4a of the key top 2, is installed in the outside upper portion of the first and second link members 5 and 6 as shown in FIG. 14.

Furthermore, first and second shaft portions 7e and 7h of the third link member 7 are installed in orthogonal direction of the protrusion direction of the first shaft portions 5e and 6e of the first and second link members 5 and 6.

As shown in FIG. 12, the third link member 7 has a substantially unshaped notch portion 7b in one end portion 7a on the lower side, and it also has one side portion 7c and the other side portion 7d which face each other in orthogonal direction to the right and left one end portions 7a, 7a with the notch portion 7b between them.

Further, the first shaft portions 7e, 7e protrude to the outside from the one side portion 7c and the other side portion 7d of the one end portion 7a. As illustrated in FIG. 13, the thickness of the first link member 7 is greater than the diameter of the first shaft portions 7e, chamfering portions 7f are formed at the front ends of the first shaft portions 7e in predetermined sizes, and the front ends of the first shaft portions 7e are tapered.

Furthermore, the third link member 7 includes second shaft portions 7h protruding in the same directions as the first shaft portions 7e in the one side portion 7c and the other side portion 7d on the other end portion 7g of the upper side facing the one end portion 7a. The other end portion 7g protrudes more to the outside than the second shaft portions 7h, and a slanted surface 7j having an angle of α is formed between the other end portion 7g and the second shaft portions 7h.

Furthermore, the elastic member 8 for determining the position of the position determining portion 2b of the key top 2 is adhered to a predetermined position of a film sheet 9, which will be discussed later, using an adhesive.

As shown in FIG. 2, the elastic member 8 applies elasticity to the key top 2 at a predetermined height C (initial position) from a base plate 10, which will be discussed later.

The elastic member 8 has a dome-shaped hollow inside. The position determining portion 2b of the key top 2 is position-determined on the top position determining portion 8a, so that the key top 2 can be position-determined on the elastic member 8.

Furthermore, a switch operating portion (not shown) is formed on a ceiling portion in the dome-shaped hollow inside. When the key top 2 is pressed to be lowered, the elastic member 8 is elastically transformed, and the switch operating portion operates a movable contact point formed on the film sheet 9, which will be discussed later, thereby converting a switch circuit.

As shown in FIG. 4, the base plate 10, on which the insulation film sheet 9 is mounted, is installed on the side facing the back surface of the key top 2.

The film sheet 9 is not shown. For example, the film sheet 9 includes a membrane switch formed by stacking three sheet members. A movable contact point is formed on a top sheet, an intermediate sheet is mounted, and a fixed contact point is formed on a bottom sheet facing the movable contact point.

When the elastic member 8 is elastically transformed by pressing the key top 2, the switch operating portion presses the top sheet to electrically connect the movable contact point to the fixed contact point, thereby converting the switch circuit.

Furthermore, the base plate 10, on which the film sheet 9 is mounted, is comprised of, for example, a metal plate such as aluminum. As illustrated in FIG. 14, first and second rotating supporting portions 10a and 10b for rotatably supporting the second shaft portions 5h and 6h of the first and second link members 5 and 6 are formed in a right angle shape and face each other.

In addition, third rotating supporting portions 10c for rotatably supporting the second shaft portions 7h of the third link member 7 are formed and face each other in orthogonal direction to the first and second rotating supporting portions 10a and 10b.

Furthermore, a plurality of drop holes 9a is formed on the film sheet 9. The first, second and third rotating supporting portions 10a, 10b and 10c of the base plate 10 are inserted into the drop holes 9a to stand straight.

Furthermore, the elastic member 8 can be adhered to the movable and fixed contact point position (not shown) of the film sheet 9 using an adhesive.

Furthermore, in the assembly process of the keyboard switch 1 according to the present invention as described above, when the film sheet 9 to which the elastic member 8 is previously adhered is put on the base plate 10, the first, second and third rotating supporting portions 10a, 10b and 10c are inserted into the drop holes 9a in the film sheet 9 to stand straight on the upper side, and the elastic member 8 is located in a predetermined position.

Next, the second shaft portions 5h, 5h of the first link member 5 are inserted into the pair of first rotating supporting portions 10a, and the second shaft portions 6h, 6h of the second link member 6 are inserted into the pair of second rotating supporting portions 10b. As a result, the second shaft portions 5h and 6h of the first and second link members 5 and 6 are supported by the first and second rotating supporting portions 10a and 10b.

In the first and second link members 5 and 6, one end portions 5a and 6a, which form the first shaft portions 5e and 6e, are rotatable from the second shaft portions 5h and 6h.

When the second shaft portions 7h, 7h of the third link member 7 are inserted into the pair of third rotating supporting portions 10c, one end portions 7a, which form the first shaft portions 7e in the third link member 7, are rotatable from the second shaft portions 7h.

The first, second and third link members 5, 6 and 7 for supporting the second shaft portions 5h, 6h and 7h by the first, second and third rotating supporting portions 10a, 10b and 10c rotate the first shaft portions 5e, 6e and 7e, and position them more closely to the elastic member 8 than the second shaft portions 5h, 6h and 7h, as shown in FIG. 14.

As a result, the first, second and third link members 5, 6 and 7 are positioned in the level state, so that the first shaft portions 5e, 6e and 7e can be located in predetermined positions of the base plate 10, respectively.

Next, in a state where the position determining portion 2b of the key top 2 is position-determined on the position determining portion 8a of the elastic member 8, when the key top 2 is pressed downward, the dome-shaped hollow inside of the elastic member 8 is elastically transformed, and the first, second and third slide supporting portions 3a, 3b and 4a of the key top 2 are positioned on the first shaft portions 5e, 6e and 7e, respectively.

When the key top 2 is pressed downward even more, the chamfering portions 3d and 4b formed on the first and second supporting walls 3 and 4 are lowered with the chamfering portions 5f, 6f and 7f of the first shaft portions 5e, 6e and 7e.

Accordingly, the notch portions 5b, 6b and 7b of the first, second and third link members 5, 6 and 7 are elastically transformed to be reduced in size, and the first shaft portions 5e, 6e and 7e are slidably inserted into the first, second and third slide supporting portions 3a, 3b and 4a of the key top 2.

When pressure applied to the key top 2 is removed, the key top 2 is lifted to the rising position of a predetermined height, namely the initial position, thereby finishing the assembly of the keyboard switch 1 of the present invention.

In the assembly process of the keyboard switch 1 according to present invention, the first shaft portions 5e, 6e and 7e of the first, second and third link members 5, 6 and 7 are automatically position-determined by merely mounting the second shaft portions 5h, 6h and 7h of the first, second and third link members 5, 6 and 7 on the base plate 10. As a result, the key top 2 can be mounted on the first, second and third link members 5, 6 and 7 by pressing it, which considerably simplifies the assembly process.

Different from the conventional keyboard switch, the keyboard switch of the present invention does not require a base frame that includes pedestals for determining the positions of the link members.

The operation of the keyboard switch 1 of the present invention as described above will now be explained. When the key top 2 located in a lifting position having a predetermined height is pressed to be lowered, a contact point operating portion (not shown) in the hollow portion of the elastic member 8 presses the movable contact point of the film sheet 9, and thus the movable contact point contacts the fixed contact point for electric connection.

As a result, the switch circuit is converted to input a signal to a personal computer, etc.

After the switch circuit is converted, if pressure applied to the key top 2 is removed, the key top 2 is lifted to the predetermined lifting position from the base plate 10 due to the elastic force of the elastic member 8 returning to the initial state.

When the key top 2 returns to the lifting position C (initial position), the movement of the first shaft portions 5e and 6e of the first and second link members 5 and 6 is restricted in the first and second slide supporting portions 3a and 3b of the key top 2. As a result, the key top 2 is prevented from being lifted over the predetermined lifting position.

At the same time, the other end portion 7g of the third link member 7 contacts the base plate 10, on which the film sheet 9 is mounted, to restrict the movement of the third link member 7.

Accordingly, when the keyboard switch 1 of the present invention has a problem, the key top 2 can be easily detached from the first, second and third link members 5, 6 and 7.

In the aforementioned embodiment of the present invention, the first, second and third link members 5, 6 and 7 have been exemplified. However, it is also possible to use only the first and second link members 5 and 6. That is, a plurality of link members is preferably used to freely lift or lower the key top 2 to/from the base plate 10.

As described above, according to the present invention, the plurality of link members of the keyboard switch has their one end portions slidably supported by the slide supporting portions formed on the key top, and their other end portions rotatably supported by the rotating supporting portions formed on the base plate. Therefore, the positions of the link members are automatically determined before mounting the key top, which simplifies the assembly process.

In addition, the keyboard switch does not require the base frame which includes the pedestals for determining the positions of the link members, thereby reducing the number of the components.

Furthermore, the plurality of link members slidably support the first shaft portions by the slide supporting portions formed on the key top and rotatably support the second shaft portions by the rotating supporting portions formed on the base plate, so that the key top can be freely lifted or lowered to/from the base plate.

The first and second link members are installed to face each other with the elastic member between them, and the third link member is positioned outside the first and second shaft portions, and has its first and second shaft portions installed in orthogonal direction to the protrusion directions of the first and second shaft portions of the first and second link members. Accordingly, the key top can be easily lifted or lowered in the level state by the first, second and third link members.

Furthermore, the elastic member applies elasticity to the center portion of the key top. The first shaft portions of the link members supported by the slide supporting portions of the key top are aligned more closely to the elastic member than the second shaft portions thereof, so they can accurately apply elasticity of the elastic member to the key top to smoothly lift or lower the key top.

When the key top reaches the predetermined lifting position, the movement of the first shaft portions of the first and second link members is restricted in the first and second slide supporting portions to prevent the key top from being lifted over the predetermined lifting position. As a result, the operation capability of the key top is improved.

The other end portion of the third link member protrudes more to the outside than the second shaft portions. When the key top is lifted to the lifting position, the other end portion thereof contacts the base plate via the film sheet to prevent the key top from being lifted over the lifting position. Accordingly, the key top can be easily detached.

Furthermore, the front ends of the first shaft portions of the link members are tapered, so that the key top can be easily mounted thereon in the assembly process.

What is claimed is:

1. A keyboard switch comprising a key top, a base plate installed on the side facing the key top, an insulation film sheet mounted thereon, an elastic member for applying elasticity to the key top at a predetermined height from the base plate, a plurality of link members for supporting the key top to be freely lifted or lowered to/from the base plate, and a contact point portion opened or closed by the lifting or lowering operation of the key top,
wherein each of the plurality of link members has one end portion and the other end portion facing each other, the plurality of link members being installed so as not to cross each other with their one end portions slidably supported by slide supporting portions formed on the key top and their other end portions rotatably supported by rotating supporting portions formed on the base plate.

2. The keyboard switch according to claim 1, wherein each of the plurality of link members has one side portion and the other side portion in orthogonal direction to the one end portion and the other end portion so that the one side portion and the other side portion face each other, first shaft portions protrude to the outside from the one side portion and the other side portion of the one end portion, second shaft portions protrude in the same directions as the first shaft portions from the one side portion and the other side portion of the other end portion, the first shaft portions are slidably supported by the slide supporting portions of the key top, and the second shaft portions are rotatably supported by the rotating supporting portions of the base plate.

3. The keyboard switch according to claim 2, wherein the plurality of link members comprises first, second and third link members, the first and second link members are installed to face each other with the elastic member between them, and the third link member is positioned outside the first and second shaft portions with the first and second shaft portions installed in orthogonal direction to the protrusion directions of the first and second shaft portions of the first and second link members.

4. The keyboard switch according to claim 2, wherein the elastic member applies elasticity to the center portion of the key top, and the first shaft portions of the link members supported by the slide supporting portions of the key top are aligned more closely to the elastic member than the second shaft portions thereof.

5. The keyboard switch according to claim 2, wherein three sets of slide supporting portions are formed to face each other, the first and second slide supporting portions for supporting the first shaft portions of the first and second link members are adjacent to first supporting walls formed on the key top, and when the key top reaches a predetermined lifting position, the movement of the first shaft portions of the first and second link members is restricted in the first and second slide supporting portions to prevent the key top from being lifted over the predetermined lifting position.

6. The keyboard switch according to claim 2, wherein the third slide supporting portions for supporting the first shaft portions of the third link member are installed on second supporting walls formed on the key top, the third link member has its other end portion more protruded to the outside than the second shaft portions, and when the key top reaches the lifting position, the other end portion contacts the base plate on which the film sheet is mounted, to prevent the key top from being lifted over the lifting position.

7. The keyboard switch according to claim 2, wherein front end portions of each of the first shaft portions of the link members are tapered.
